(19) United States
(12) Patent Application Publication
(10) Pub. No.: US 2025/0013513 A1
(43) Pub. Date: Jan. 9, 2025

(54) DELIVERING APPLICATIONS ON DEMAND WITH UNIFORM RESOURCE IDENTIFIERS

(71) Applicant: Omnissa, LLC, Mountain View, CA (US)

(72) Inventor: Jeffrey Paul Ulatoski, Oakland, CA (US)

(21) Appl. No.: 18/347,312

(22) Filed: Jul. 5, 2023

(51) Int. Cl. G06F 9/54; G06F 8/61

(52) U.S. Cl. CPC G06F 9/547; G06F 8/61

(57) ABSTRACT

A computerized method of executing an application based on a uniform resource identifier (URI) includes receiving user input indicating activation of the URI. The URI includes a scheme name, an application identifier for an application, and a launch identifier. The method also includes identifying an agent service registered to process the URI based on the scheme name. The method further includes transmitting an application request to an application manager server, the application request including at least the application identifier and the launch identifier, and receiving, from the application manager server, an assignment of a virtual disk associated with the application and an execution path of the application. The method also includes mounting the virtual disk and executing the application from the virtual disk using the execution path.

### BACKGROUND

A uniform resource locator (URL) is a string of characters representing a standardized address (e.g., a location) of a resource on computer networks, such as the Internet. A URL typically includes a scheme (e.g., “http”, “https”, “ftp”) followed by a “://” separator, then a domain name (e.g., “www.example.com”), a path (e.g., “/page1.html”), and optionally one or more query parameters that provide additional information for the request (e.g., preceded by a question mark “?” and separated by ampersands (“&”)) or a fragment identifier. URLs are most commonly used to access web pages.

URLs are a type of uniform resource identifier (URI). URIs represent a broader way to identify and access resources on computer networks. URIs can be used for web browsing (e.g., as the URLs described above), hyperlinking between web pages, or as hyperlinks pointing to particular images, documents, or other resources or digital assets. URIs can be used to access and interact with application programming interfaces (APIs) exposed by network-based servers (e.g., to access some specific functionalities or data from a web service). Different URI schemes can be used for particular purposes beyond web browsing. For example, the “mailto:” scheme is used to specify email addresses. As such, when a user clicks on a “mailto:” link, the local operating system typically launches a default email client with a new email composition window pre-populated with a specific recipient's email address identified in the URI.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In some examples, a computerized method of executing an application based on a uniform resource identifier (URI) is provided. Solutions include: receiving, at a client computing device, user input indicating activation of the URI, the URI comprising a scheme name, an application identifier for an application, and a launch identifier; identifying, by the client computing device, an agent service registered to process the URI based on the scheme name; transmitting an application request to an application manager server, the application request including at least the application identifier and the launch identifier; receiving, from the application manager server, an assignment of a virtual disk associated with the application and an execution path of the application; mounting, at the client computing device, the virtual disk; and executing the application from the virtual disk using the execution path.

### BRIEF DESCRIPTION OF THE DRAWINGS

The present description will be better understood from the following detailed description read in the light of the accompanying drawings, wherein:

FIG. 1 illustrates an example architecture that advantageously delivers and/or executes applications via URIs;

FIG. 2 is a sequence diagram that illustrates an example process for configuring the application manager to provide on-demand (OD) application URIs for OD application packages within an example architecture such as that of FIG. 1;

FIG. 3 is a flowchart of an example process for using the OD application URIs to deliver and execute the OD applications provided by an example architecture such as that of FIG. 1;

FIG. 4 is a sequence diagram that illustrates an example process for using the OD application URIs to deliver and execute the OD applications provided by an example architecture such as that of FIG. 1;

FIG. 5A is an example user interface and associated screen for administering OD applications and their associated OD application packages on the application manager;

FIG. 5B illustrates another example of the launch links list, but for another example OD application that includes a suite of applications, each of which has their own distinct launch link;

FIG. 6 illustrates an example virtualization architecture that may be used as a computing platform; and

FIG. 7 illustrates a block diagram of an example computing apparatus that may be used as a component of an example architecture, such as the architectures of FIG. 1 and FIG. 6.

Any of the figures may be combined into a single example or embodiment.

### DETAILED DESCRIPTION

Some existing virtualization environments provide a virtual desktop infrastructure (VDI) and/or a remote desktop session host (RDSH) server that allows users to remotely access a virtual desktop. For example, a user executes a client application from their personal computing device to communicate with a connection server. The connection server authenticates the user and coordinates establishing a desktop session between the client application and the VDI, the RDSH, or the like. The user can then execute an application through this desktop session.

In some existing systems, applications are made available to users through a connection server and/or an application manager. The connection server brokers and manages client connection requests to the virtualization environment, and may manage and provide access to some applications (server-managed (SM) applications) for desktop sessions. The application manager manages and provides access to on-demand (OD) applications, which are separately hosted by the application manager.

Some existing systems can be configured to use uniform resource identifiers (URs) to execute applications locally on a computing device. For example, a protocol handler can be configured on a local operating system (OS) to allow custom URI schemes to be associated with specific applications or actions on a computer. For example, a scheme can be registered with the protocol handler for a particular application that is installed on the computer. As such, when a link referencing that scheme is activated (e.g., clicked on by the user), the protocol handler activates the associated application, and possibly with some particular desired action (e.g., specified by other parameters of the URI). However, this type of URI application execution presumes the application is already installed on the local computer, and that the application has already been registered with the protocol handler to handle URIs referencing that application.

In contrast, some example systems and methods facilitate access to on-demand applications using URIs. An application agent is installed on a computing device (an “agent device”), such as a user computing device, a virtual machine, a remote desktop server host of a virtualization architecture providing virtual desktop sessions, or the like. The agent device includes a URI handler (e.g., a protocol handler) that is configured to handle URI links on the agent device. More specifically, the URI handler is configured to invoke the application agent whenever a URI link having an associated scheme, such as “OnDemandApp:// . . .”, is activated (e.g., clicked via user input). As such, the scheme “OnDemandApp” becomes associated with the application agent on the agent device.

An application manager makes on-demand applications available to the agent device. The application manager can provide applications to the agent device via installation packages (e.g., where the agent device downloads and locally installs applications when requested), or via disk provisioning and mounting onto the agent device (e.g., where the agent device mounts a disk or virtual disk on which applications are already installed).

During configuration, a new URI is created for a particular application. The application manager identifies an application ID for the application (e.g., an “OD application GUID” that uniquely identifies the particular application). Further, the application manager also creates a launch ID for this new URI (e.g., an “OD launch ID” representing a launch path to be used for executing the application, once the application is available on the agent device). A URI is then created with the scheme, the OD application GUID, and the OD launch ID. An example on demand application URI may be “OnDemandApp://launch?appid=XXXXX&launchid=YYYYY”, where the scheme is “OnDemandApp”, an action is “launch” (e.g., a command to launch an application using the following application data), an “appid” identifies the application to launch (where XXXXX is the OD application GUID), and “launchid” identifies the launch ID (where YYYYY is the OD launch ID). This URI link may then be shared to and amongst users, such as in emails, instant messages, documents, or the like.

During operation, when a user activates the URI on the agent device, the URI handler of that agent device identifies the scheme associated with the application agent from the URI and calls the application agent to process the URI. The application agent parses the OD application GUID and the OD launch ID from the URI. In some situations, the particular application referenced by the URI may already be available on the agent device. For example, if the application had been previously mounted or installed on the agent device, such as through a previous activation of this URI, then the application agent can identify the already-available application by the OD application GUID. As such, the application agent may then execute the application on behalf of the user (e.g., using a launch path determined from the launch ID, or the like). In other situations, that particular application may not yet be available on the agent device. In such situations, the application agent generates and transmits an application request to the application manager. The application request includes the GUID to identify which particular application or application package is being requested. The application manager identifies the application and may perform user entitlement verification for the request (e.g., to verify that the requesting user is entitled to run the requested application). The application manager provisions the requested application to the requesting agent, for example, as a mountable virtual disk, as an installation package from which the agent can perform an install on the agent device, or the like. The application manager also responds with launch path information identifying how to launch the application. The agent mounts or installs the application to enable use of the application by the user, and may virtualize the application before use.

Examples of the disclosure improve the operations of the computer by facilitating a way to initiate applications on demand through sharable URI links. The sharable nature of URIs in combination with the on-demand delivery of applications allows the example architectures and methods to allow the user devices (e.g., virtual machines or desktops) and their underlying infrastructure architecture to mount/install application packages only when needed by users. This reduces computational overhead and processing, storage, and network traffic involved with unnecessary software installations or mounts, and/or unnecessary storage demands, in situations where users do not need particular applications. Further, the use of URIs facilitates both a shareable vector for application access, as well as a convenient access point for on-demand applications, allowing URIs to be linked in documents, shared amongst colleagues, delivered to users for access, or the like.

While described with reference to VMs in various examples, the disclosure is operable with any form of virtual computing instance (VCI) including, but not limited to, VMs, containers, or other types of isolated software entities that can run on a computer system. Alternatively, or additionally, the architecture is generally operable in non-virtualized implementations and/or environments without departing from the description herein.

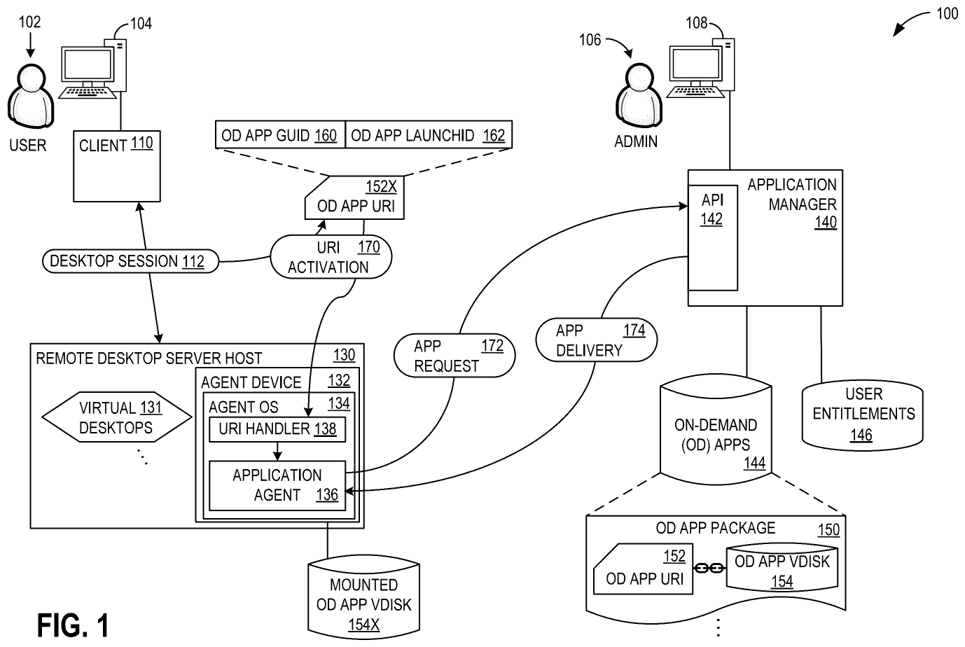

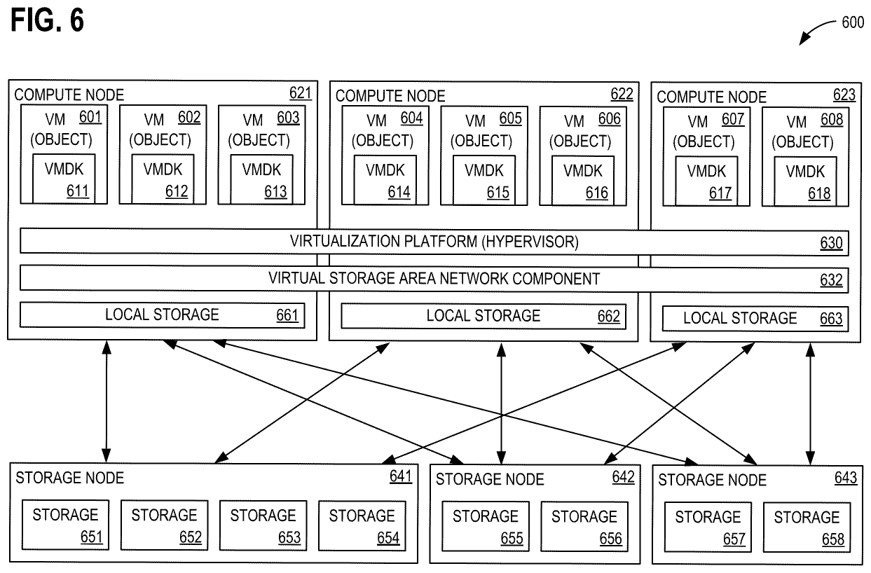

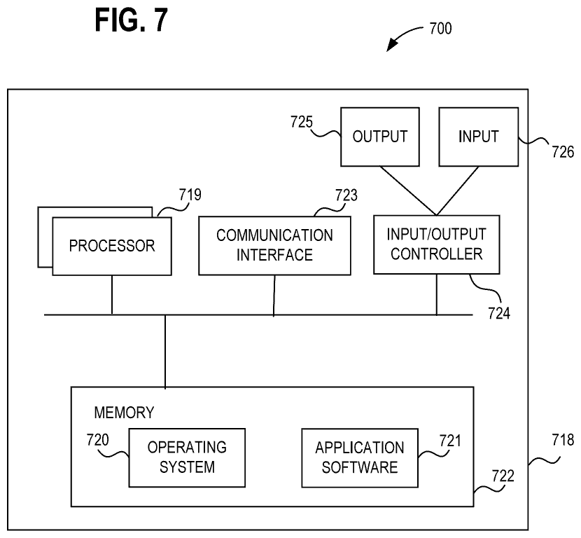

FIG. 1 illustrates an example architecture 100 that advantageously delivers and/or executes applications (apps) via URIs. Architecture 100 uses a computing platform which may be implemented on one or more computing apparatus 718 of FIG. 7, and/or using a virtualization architecture 600 as is illustrated in FIG. 6. In this example, a user 102 uses a user device 104 to execute applications provided by the architecture 100. The architecture 100 includes a system that provides on-demand applications to users 102, namely an application manager 140. More specifically, the application manager 140 manages a group of applications referred to herein as on-demand applications (or “OD applications”) 144, and each of these OD applications 144 may have an OD application package 150. These OD applications 144 are referenced and executed by the user via activation of an OD application URI 152, or a “URI activation” 170, as described below. It should be understood that the application manager 140 may manage numerous OD applications 144, each of which may have their own OD application package 150. For purposes of discussion, a particular OD application URI 152X and associated OD application vdisk 154X is shown and discussed in relation to FIG. 1.

In the example architecture 100 shown in FIG. 1, a remote desktop server host (RDSH) 130 provides a desktop session 112 (e.g., virtual desktops 131) to client devices such as client device 104 (e.g., via client 110 acting as interface software). The RDSH 130 provides virtual machines (VMs) or other virtualized computing resources which are used to provide these virtual desktops 131 to users 102. One example VM is shown here as agent device 132, in the sense that this VM executes an application agent 136 that works with the application manager 140 to provide OD application delivery and execution as described herein. The agent device 132 is executing an agent OS 134 (e.g., a version of Microsoft Windows, Linux, MacOS, or the like). The agent OS 134 includes a URI handler 138, which is a protocol handler for processing the activation of URI links. The application agent 136 is a client-side software component that executes on the agent device 132 and that facilitates the receipt and execution of OD applications 144 on the agent device 132, such as mounting vdisks 154 or installing OD applications 144 on the agent device 132 and executing those OD applications 144 for the user. Further, the application agent 136 is also configured as the handler for URI links associated with this on-demand application architecture 100 as described herein.

During an application configuration process, an administrator (“admin”) 106 uses an admin computing device 108 to configure a particular OD application 144 for use in the architecture 100, namely an OD application package 150. This OD application package 150 includes a particular application and associated files. In “provisioning” examples, and as shown in FIG. 1, a virtual disk (e.g., “OD application vdisk” 154) is created for the OD application 144 and that vdisk 154 stores files and other data associated with the application. For example, the vdisk 154 and associated package 150 may be prepared by performing a preparatory installation of the application onto the vdisk 154, and may include capturing other installation details of the application specific to a particular operating system or OS version and/or application or application version (e.g., creating an AppStack), such as application dependencies, registry settings, file system changes, and the like. This vdisk 154 may then be provisioned to other computing devices, allowing the computing devices to execute the application from that vdisk 154. In “installation” examples, the OD application package 150 includes an installation package, executable binaries, or the like, that are transmitted to the requesting device and that requesting device performs an installation of the application or otherwise stages the application files on persistent storage available to the requesting device. It should be understood that the vdisk 154 can be any type of virtual disk storage that can support the systems and methods described herein, such as, for example, a virtual machine hard disk (VMDK) of VMware, virtual hard disk (VHD) of Microsoft Hyper-V, or the like.

In addition to preparation of the OD application vdisk 154 for an OD application 144, the application manager 140 also creates an OD application URI 152 that can be used to reference and execute this package 150. In an example, each OD application URI 152 includes a scheme name, a command name, an OD application GUID 160, and an OD launch ID 162. The scheme name is a character string that is assigned for use by the application manager 140 and its agents (e.g., application agent 136). The command name is a character string that identifies commands that can be sent to the application manager 140 or agents 136 (e.g., to facilitate the various on-demand application operations described herein). The OD application GUID 160 is a unique identifier for the particular OD application package 150, which may be created and assigned to the OD application package 150 by the application manager 140, such as during preparation of the OD application 144 and its associated OD application package 150. The OD application launch ID 162 is an identifier that can be used in launching the application, once the associated OD application 144 is enabled for use. The application manager 140 creates and formats this URI 152 as a string of characters with connecting punctuation, as is known in the art with URIs.

For example, a version of the application “Windows Notepad++” in the Windows 10 operating system can be packaged (as an example OD application 144) into an OD application package 150X (not separately shown), and more specifically has been installed onto an OD application vdisk 154X. This is depicted in a mounted configuration in FIG. 1, but initially begins this example as not yet provisioned by the application manager 140. This particular application has an entry point of “C:ProgramDataMicrosoftWindowsStartMenuProgramsNotepad++.lnk”. If the application manager 140 is configured to use a scheme name of “OnDemandApp” for the URIs 152, the application manager 140 creates a URI for this OD application package 150 with a general format of:
<scheme name>://<cmd>?appid=<OD app GUID>?launchid=<OD app launch ID>.
   In this case, since the example <scheme name> is “OnDemandApp” and an example command <cmd> for requesting launch of a particular application is “launch”, then an example OD application URI 152X may be:
OnDemandApp://launch?appid=<OD app GUID>?launchid=<OD app launch ID>,
   where COD app GUID> is a unique ID for the OD application 144 or the OD application package 150 (e.g., OD application GUID 160), and where the COD app launch ID> is a string that is used to identify the entry point for this application once mounted/installed on an agent device (e.g., OD application launchID 162). In some examples, the OD application launch ID 162 may be the launch path of the application (e.g., the windows path of the entry point as provided above). In other examples, the entry point is hashed or otherwise encrypted to generate the OD application launch ID 162. Hashing of the path can both encrypt the path as well as convert what can be a differing number of characters in a path string into a fixed number of characters, regardless of the size of the input. In examples, commands (“<cmd>”) can include “deliver” (e.g., an instruction to request delivery of an application without an execution of the application, if the application is not already enabled), “launch” (e.g., an instruction to request delivery of the application if not already enabled, along with execution of that application once enabled), or similar commands. In some examples, the OD application launch ID 162 is the same for multiple versions of the underlying application (e.g., where different versions of the application may use the same launch path or entry point, the hash is identical). This overlap allows the application manager 140 to deliver a current or otherwise assigned version of the application irrespective of the URI 152 or of the specific OD app package 150 (e.g., where the launch ID 162 can resolve to different versions of the application). As such, the architecture 100 can deliver the application without launch even if the launch ID 162 is not able to resolve. This allows for users to still use the application via a manual, user-initiated launch, even when changes to application launch points may have changed.

After creation of this example URI 152X, the application manager 140 stores the URI 152X for this particular OD application package 150X. At this stage, the package 150 is prepared for use and may be entitled to various users (e.g., via a user entitlements database 146 or other such access control scheme).

The OD application URI 152X for this application may be published and circulated after configuration. For example, the URI 152X may be circulated via email, messaging applications, embedded as a link in a document, or the like. In this example, it is presumed that the user 102 has received the OD application URI 152X for this package 150 via the user computing device 104 and client 110 as the user 102 operates the desktop session 112 provided by the RDSH 130. For example, the user 102 may be viewing their email client running on the agent device 132 and may have received the URI 152X as a clickable link in an email.

When the OD application URI 152X is activated (e.g., when the user 102 clicks on a link for the URI 152X, as represented in FIG. 1 by URI activation 170), the URI handler 138 is automatically engaged to process this URI activation 170 (e.g., for this and any other URIs that may be activated on the agent device 132). The URI handler 138 parses the URI to identify the scheme name included in the URI 152X and route the processing accordingly. More specifically, in this example, the URI 152X includes the scheme name “OnDemandApp”, and the application that has been previously configured to process requests for this scheme name is the application agent 136. As such, the URI handler 138 passes this URI on to the application agent 136 for processing.

The application agent 136 parses the URI 152X to identify the contents of the URI 152X, including a command (e.g., “<cmd>,” above), an OD application GUID 160, and an OD application launch ID 162. The application agent 136 uses the OD application GUID 160 to determine whether that particular package 150 is already enabled, installed, or otherwise already locally available on the agent device 132. For example, the application agent 136 may maintain a database of OD application packages 150 that are currently enabled on the agent device 132 (e.g., as OD applications 144 are mounted and unmounted), as well as other application data such as their associated OD application GUIDs. In situations where the OD application GUID 160 matches an OD application 144 that is already enabled on the agent device 132, the application agent 136 may immediately execute the application for the user 102, or may transmit a user entitlement request to the application manager 140 with user details to verify that this particular user 102 is entitled to run the requested application (e.g., based on the OD application GUID 160 and user ID, or the like).

In situations where the application is not already enabled on the agent device 132, then the application agent 136 is configured to communicate with the application manager 140 to facilitate an on-demand delivery and execution of the application. More specifically, the application agent 136 creates and transmits an application request message 172 to the application manager 140. The application request message 172 includes the OD application GUID 160 and may include other application request details, such as user information for the requesting user 102 or the OD application launch ID 162.

In response to receipt of the application request 172, the application manager 140 identifies the particular OD application package 150 associated with the given OD application URI 152X and provisions that package 150X to the requesting agent device 132 (e.g., as application delivery 174). In the example, the OD application vdisk 154X of the package 150X is provisioned to the RDSH 130 and the agent device 132, and the application agent 136 mounts that vdisk 154X on the agent device 132. In other examples, application files of the package 150X may be transmitted to the agent device 132 and the application agent 136 may perform a software installation or otherwise stage the application files for execution. In some examples, the application delivery 174 includes additional data about the package 150X, such as the execution path or launch path of the application (e.g., directory path to the root executable, or the like), execution parameters for the application, or software information about the application (e.g., package name, application version, OS version, software dependency information, or the like), user entitlement information (e.g., list of user IDs privileged to execute this application), and the like.

In examples, the application manager 140 provides an API 142 for various communications with the application agent 136. The API 142 may accept application requests 172. In addition, the API 142 may also facilitate additional endpoints for other requests. For example, the API 142 may facilitate a “GET” for various application data, to which the API 142 response with a list of OD application packages 150 is made available by the application manager 140, as well as associated package information, or for a particular package 150X. The information may include application name, description, OD application GUID 160, OD application launch ID 162, mount commands, entry point, shortcuts, application run command, available application versions, attributes, and delivery or launch URIs.

Upon mounting of the OD application vdisk 154X on the agent device 132 and receipt of the execution path for the application, the application agent 136 executes the application on the agent OS 134 (e.g., using the execution path). The application agent 136 may update the status database to identify that this application is now enabled on the agent device 132. As such, the URI activation 170 initiated by the user 102 causes the application agent 136 to enable the OD application package 150 on the agent device 132 and execute the application on behalf of the user 102. In some examples, the application agent 136 may be configured to execute the application at an elevated privilege level (e.g., under a user other than the user 102), and thus may also facilitate privileged execution of OD applications 144.

While the architecture 100 shown in FIG. 1 illustrates the application agent 136 executed by the RDSH 130 (e.g., where the agent device 132 is a VM or the like, and the user 102 views and interacts with the OD application URI 152X via a desktop session 112), it should be understood that the agent device 132 may be another computing device (e.g., a device operating in a non-virtualized environment). For example, the user computing device 104 may be configured with the application agent 136 and, as such, the user computing device 104 may be the agent device 132. In such an architecture, the agent OS 134 may be an OS locally installed on the user computing device 104, and the URI activation 170 may occur within that agent OS 134 running on the user computing device 104.

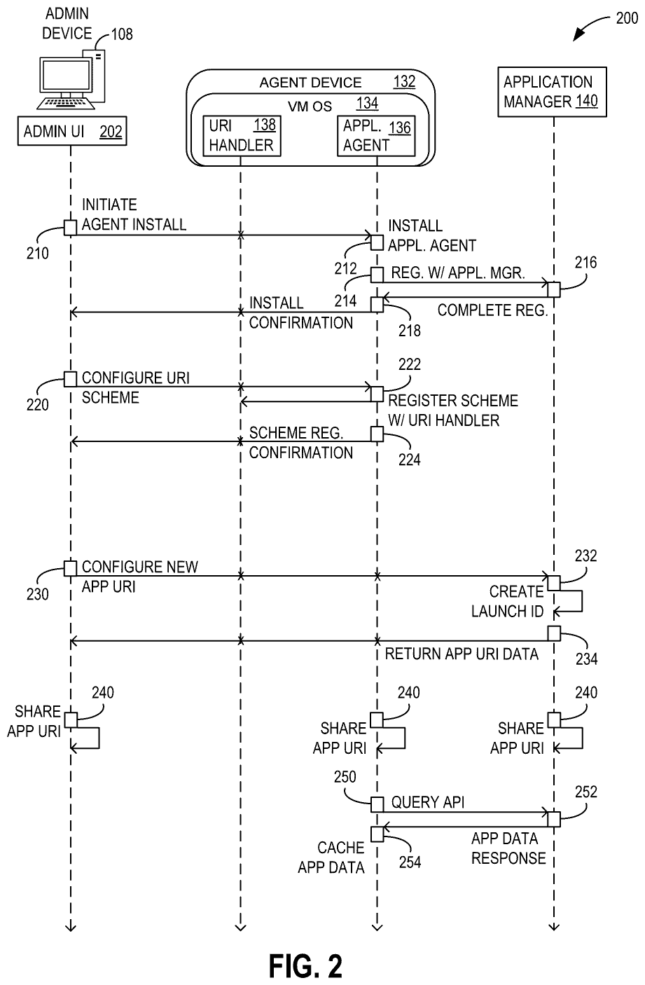

FIG. 2 is a sequence diagram that illustrates an example process 200 for configuring the application manager 140 to provide OD application URIs 152 for OD application packages 150 within the architecture 100 of FIG. 1. In this example, an admin user interface (UI) 202 is provided on the admin device 108, through which the admin 106 may administer the application manager 140 and application agent 136. At 210, the admin device 108 initiates an agent installation to install the application agent 136 on the agent device 132. At 212, an installation of the application agent 136 is performed on or within the OS of the agent device 132 (e.g., on the VM OS 134). At 214, the application agent 136 communicates and registers with the application manager 140 (e.g., using credentials for the application manager 140), and the application manager 140 responds with a registration confirmation message to complete the registration of that agent 136 at 216. This registration allows the application agent 136 to request and mount the various OD applications 144 made available by the application manager 140 (e.g., via the associated OD application packages 150). At 218, the application agent 136 confirms the agent installation with the admin device 108.

In this example, the agent device 132 is also configured to redirect particular URI activations 170 to the application agent 136 (e.g., to intercept and process URIs with the “OnDemandApp://” scheme). More specifically, at 220, the admin device 108 sends a configuration request to configure the agent device 132, and more particularly the URI handler 138 of the VM OS 134, to redirect the “OnDemandApp” scheme to the application agent 136. In some examples, the scheme name may be provided by the admin 108, where in other examples, the scheme name may be a name assigned by the application manager 140 or the application agent 136 (e.g., as a standard scheme name used across this architecture). At 222, the application agent 136 registers this scheme name with the URI handler 138, identifying the application agent 136 as the process responsible for responding to URIs having that scheme name. As such, after this registration, the application agent 136 is configured to receive any incoming URIs 152 having the scheme name of “OnDemandApp”. At 224, the application agent 136 sends a confirmation message to the admin device 108 confirming the registration of the scheme name on the agent device 132.

In this example, and for the remainder of the operations shown in FIG. 2 to FIG. 4, the OD application package 150X (e.g., the example “notepad++” application discussed above) is used by way of example, and it is presumed that an OD application package 150X has already been configured for use as an OD application 144 on the application agent 136. As such, it is presumed that the OD application package 150X has a configured entry point or launch path, such as “C:ProgramDataMicrosoftWindowsStartMenuProgramsNotepad++.lnk” in this example application, as well as a unique application ID (OD application GUID 160) assigned to this OD application package 150, as well as other application data that may be used in provisioning or installation of these OD applications 144. It is also presumed that the application has been installed on the OD application vdisk 154X and that vdisk 154X is prepared for provisioning (e.g., in provisioning examples such as shown in FIG. 1), or that the application files are otherwise available for transfer (e.g., in installation examples).

At 230, the admin device 108 configures a new OD application URI 152X for this OD application package 150X. In the example, the creation of this OD application URI includes creating a URI-formatted string using the scheme name “OnDemandApp”, a command such as “launch” or “deliver”, the OD application URI 160, and a launch identifier (e.g., OD application launchID 162). At 232, if the OD application launchID 162 has not yet been created for this OD application package 150X, then the application manager 140 creates the OD application launchID 162. In some examples, the OD application launchID 162 may be a plaintext character string of the entry point or launch path. In this example, the application manager 140 hashes the plaintext string of the launch path (e.g., as a MD5 hash, or the like) to create the OD application launchID 162, thereby generating a fixed length, encrypted digest of the launch path. In other examples, other encryption methods can be used to generate the OD application launchID 162. As such, the example OD application URI 152X is generated for this OD application package 150 as:
OnDemandApp://launch?appid=<OD app GUID>?launchid=<OD app launch ID>
   At 234, the application manager 140 transmits a confirmation message back to the admin device 108 confirming the creation of the OD application URI 152X for this package 150X, and may return the OD application URI data as well (e.g., the string itself, a link that embeds the string, or the like).

As such, the OD application URI 152X for the example OD application package 150X is now prepared and ready for use. At 240, the OD application URI 152X may be shared amongst users 102 and other devices in the architecture 100.

In some examples, the application agent 136 may be configured to query the application manager 140 (e.g., via the API 142) for various application data or other requests. At 250, the application agent 136 may transmit a query message to the API 142 to, for example, provide a list of OD application packages 150 made available by the application manager 140. At 252, the application manager 140 responds with the requested application data, which may include details for each package such as OD application GUID 160, OD application launchID 162, entry point or launch path (e.g., in encrypted or unencrypted form) to use for the package 150 during execution, or the like. At 254, the application agent 136 may cache any or all of this application data for use during operation.

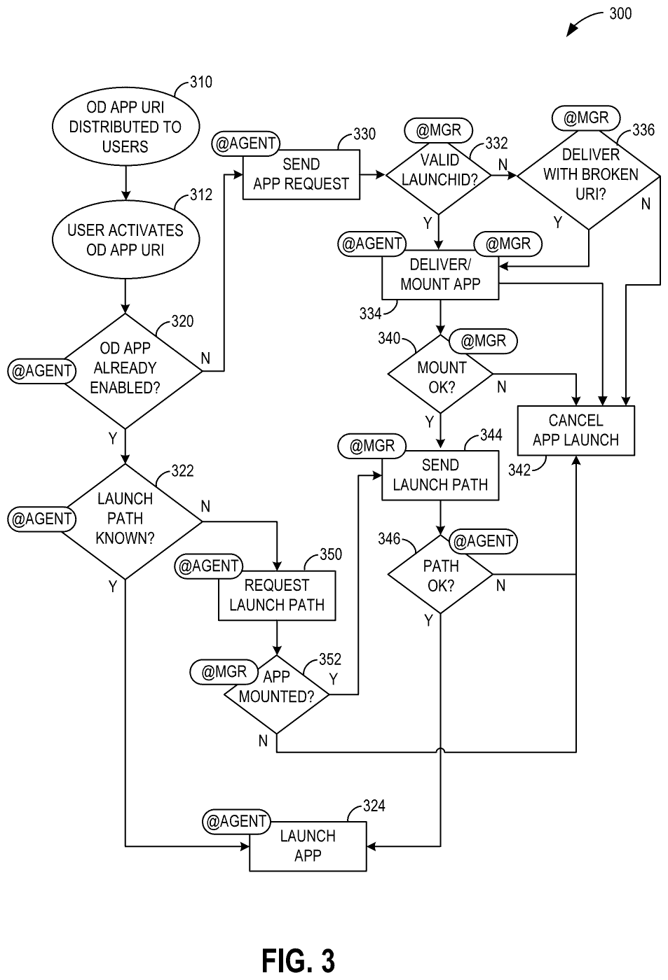

FIG. 3 is a flowchart of an example process 300 for using the OD application URIs 152 to deliver and execute the OD applications 144 provided by the architecture 100 of FIG. 1. Some operations are identified in FIG. 3 as being performed by the application agent 136 (“@AGENT”) and other operations are identified as being performed by the application manager 140 (“@MGR”). It is presumed that the example OD application 144 and associated OD application package 150X is prepared for provisioning within the architecture 100, and that the example OD application URI 152X has been created and assigned to the “notepad++” example application as described in FIG. 2. In this example, the OD application URI 152X is distributed to users within the architecture 100 (e.g., to user 102) at 310. At 312, the user 102 activates the OD application URI 152X (e.g., by clicking a link to the URI 152X within the client 110 and desktop session 112 provided by the agent device 132). This URI activation 170 causes the application agent 136 to process the OD application URI 152X.

At test 320, the application agent 136 identifies the OD application GUID 160 and OD launch ID 162 from the OD application URI 152X and determines whether the associated OD application package 150X is already enabled for the user 102 on the agent device 132, such as by comparing the OD application GUID 160 of the URI 152X to a database of OD application packages 150 already enabled on device 132. In situations where the requested application is already enabled on the device 132, the agent 136 proceeds to test at 322 to determine whether a launch path is already known for the requested application. For example, the launch path may already be known from when the user 102 initially logged into the agent device 132 (e.g., into the desktop session 112 provided by the RDSH 130, as shown in FIG. 1, or into the user computing device 104 when acting as the agent device 132). If the launch path is already known for this package 150X, then the agent 136 proceeds to launch the application at 324 (e.g., using the known launch path for this package 150X). As such, in situations where the requested application is already enabled and the launch path is already known, the agent 136 is able to perform a prompt execution of the application for the user 102 in response to the request (e.g., without necessarily communicating with the application manager).

In situations where the OD application package 150X is enabled but the launch path is not known, then the agent 136 creates and transmits a launch path request to the application manager 140 at 350. At test 352, the application manager 140 receives the launch path request and determines whether the requested application has already been provisioned to the requesting agent device 132 (e.g., using OD application GUID 160, OD launch ID 162, and an ID of the agent 136 or agent device 132). If this launch path request is for an application that is not already provisioned to the requesting agent 136, then the launch of this application is cancelled at 342. If this application is provisioned to the requesting agent 136, then the application manager 140 sends the launch path for that application to the requesting agent 136 at 344. Upon receipt of the launch path at the agent 136, if the launch path is properly received and verified at test 346, then the agent 136 launches the application at 324 and may cache the launch path for subsequent launches of this same application.

Returning again to test 320. In situations where the application associated with the OD application GUID 160 is not already enabled on the agent device 132, then the agent 136 creates and sends an application request 172 to the application manager 140 at 330. The application manager 140 identifies the OD application GUID 160 from the application request 172 and determines whether the OD application GUID 160 and/or the OD launch ID 162 is valid at test 332. If the GUID 160 and launch ID 162 are valid, then the application manager 140, at 334, provisions the associated OD application package 150X to the agent 136 and the agent 136 mounts the associated OD application vdisk 154X to the agent device 132 or otherwise installs the provisioned package 150X for execution. At test 340, if the provisioning of the package 150X (e.g., mounting of OD application vdisk 154X) is confirmed as successful, then the application manager 140 sends the launch path for the package 150X to the agent 136 at 344 and the agent 136 proceeds through 346 to launch the application at 324. If the mount fails at 340, then the launch of the application is cancelled at 342.

Returning to test 332, in some situations, the OD launch ID 162 may be invalid or otherwise not match the launch ID configured for the package 150X. In such situations, the application manager 140 may be configured to handle this “broken URI” situation in one of two ways. If, at test 336, the application manager is configured to deliver the application but not to execute the application in this scenario, then operation 334 is performed, thus delivering the application to the agent 136. If, at test 336, the application is configured to cancel delivery and launch in a broken URI scenario, then the process diverts directly to operation 342 without delivering the application or executing.

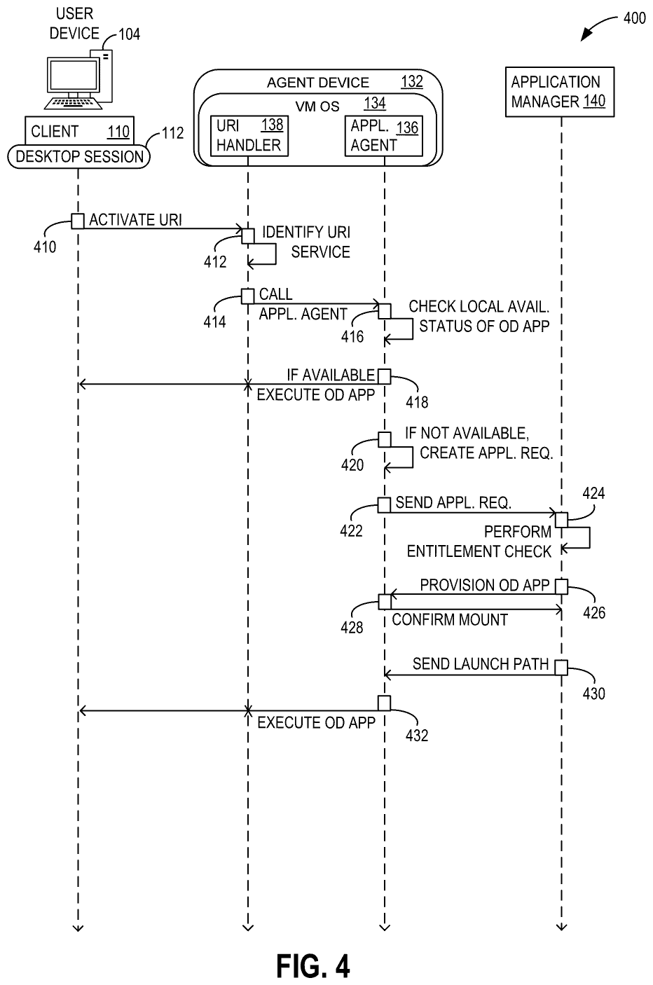

FIG. 4 is a sequence diagram that illustrates an example process 400 for using the OD application URIs 152 to deliver and execute the OD applications 144 provided by the architecture 100 of FIG. 1. In some examples, process 400 may be similar to the process 300 shown in FIG. 3. Like FIG. 3 above, it is presumed that the example OD application 144 and associated OD application package 150X is prepared for provisioning within the architecture 100, and that the example OD application URI 152X has been created and assigned to the “notepad++” example application as described in FIG. 2. In this example, the user device 104 executes the client 110 and establishes the desktop session 112 with the RDSH 130 of FIG. 1 and, in an example, to a VM providing the desktop session 112 and acting as the agent device 132. In other architectures, the user device 104 may be the agent device 132.

In this example, the user 102 has activated the OD application URI 152X via the desktop session 112 (e.g., clicking on a URI link or the like). At operation 410, URI activation 170 causes the URI handler 138 to process this URI activation 170. At 412, the URI handler 138 parses the OD application URI 152X to identify the scheme name (e.g., “OnDemandApp”). Since this scheme name has been previously registered to the application agent 136 (e.g., during the installation process shown in FIG. 2), the URI handler 138 calls the application agent 136 to process this URI activation 170 at 414.

During processing of the URI activation 170, the application agent 136 checks the local availability status of the requested application at 416. For example, the application agent 136 parses the OD application GUID 160 and OD application launchID 162 from the OD application URI 152X and compares the information to OD application packages 150 that have already been mounted or installed on the agent device 132. In situations where the associated application package 150X is already enabled on the agent device 132 and if the execution path of the application is known, the application agent 136 executes the application on behalf of the user 102 at 418 (e.g., using a cached execution path acquired when the package 150X was previously enabled).

In situations where the associated application package 150X is not yet enabled on the agent device 132, the application agent 136 creates an application request message 172 at 420 and sends that application request to the application manager 140 at 422. The application manager 140 receives the application request message 172 at 424 and performs a user entitlement check for the package 150X (e.g., to verify that the OD application GUID 160 is a valid OD application package 150, that the OD application launchID 162 matches the launchID of the package 150X, and that the requesting user 102 is entitled to execute this particular application). Upon successful verification, the application manager 140 provisions the OD application package 150X to the agent device 132 (e.g., mounting the OD application vdisk 154X) at 426. At 428, the application agent 136 confirms the provisioning of the package 150X with the application manager 140. At 430, the application manager 140 sends a launch path message to the application agent 136 that includes the execution path of the application. At 432, the application agent 136 executes the application using the execution path.

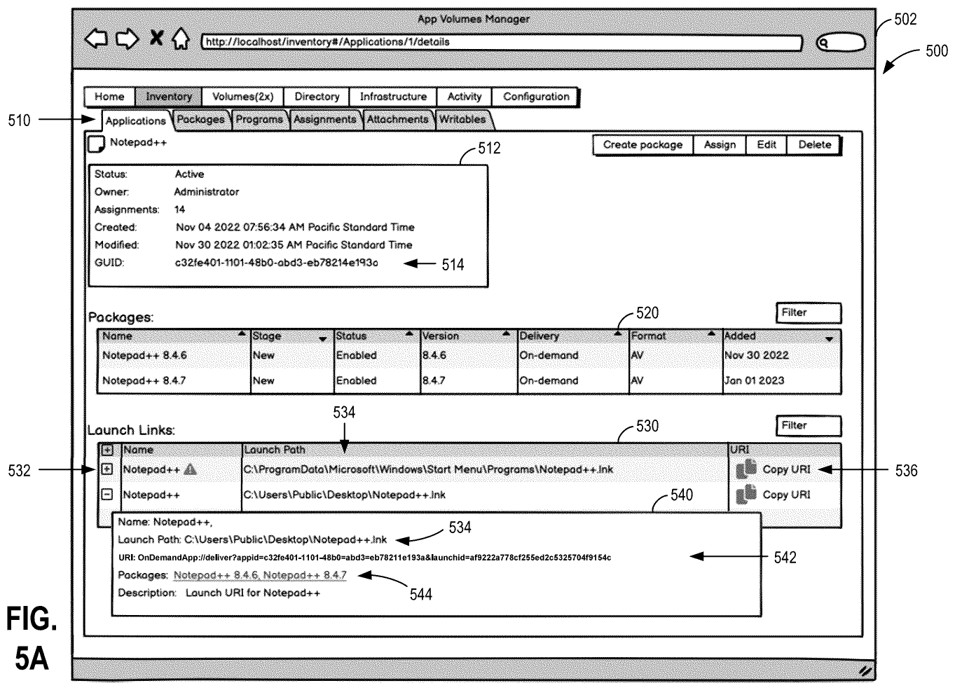

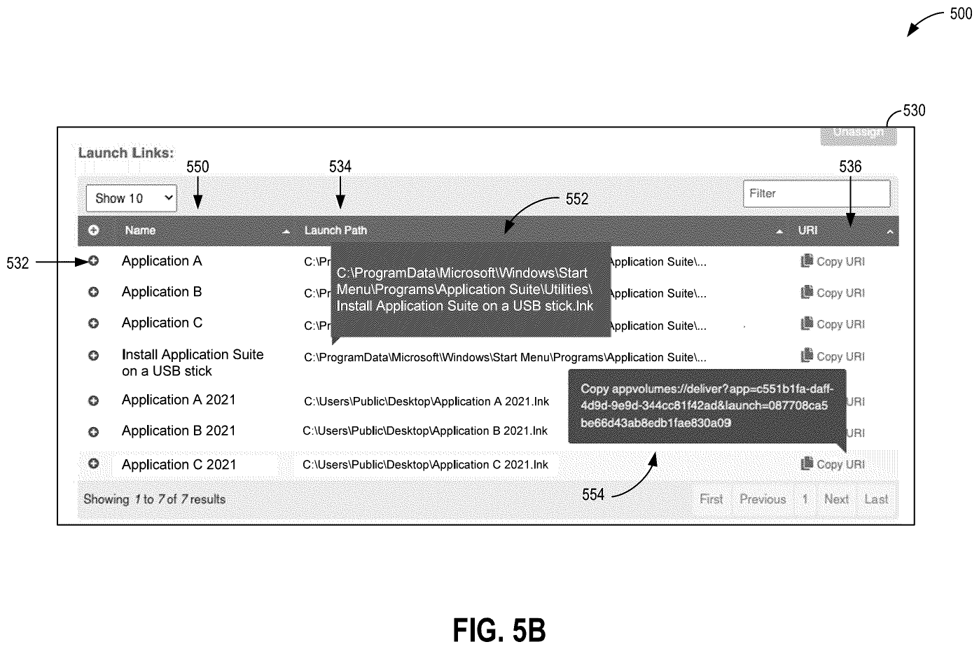

FIG. 5A is an example user interface 500 and associated screen 502 for administering OD applications 144 and their associated OD application packages 150 on the application manager 140. The user interface 500 may be similar to the admin UI 202 of FIG. 2 and may be displayed on the admin device 108 of FIG. 1. In the example, the screen 502 is shown on an “Applications” tab 510. This tab 510 displays an application data frame 512 that includes various information about a particular OD application 144 (e.g., the “notepad++” application used in the above examples). Notably, this application data area 512 shows an OD application GUID 514 assigned to this OD application 144. A packages list 520 identifies two OD application packages 150 associated with this application (e.g., a “Notepad++8.4.6” and a “Notepad++8.4.7”, being two different versions of the “notepad++” application).

The example tab 510 also displays a launch links list 530 that identifies two distinct launch paths 534, each of which includes a name, a launch path 534, and an associated URI link copy button 536 for this application. The second launch link is expanded in this example to show a link details pane 540. This link details pane 540 displays a name for the link (e.g., “Notepad++”), the launch path 534 (e.g., an execution path of a link, binary, or other file that can be used to execute this application), a URI 542 for this link (e.g., the OD application URI 152X), and package hot link(s) 544 that embed this URI 542.

FIG. 5B illustrates another example of the launch links list 530, but for another example OD application 144 that includes a suite of applications, each of which has their own distinct launch link 532. The list 530 shown in FIG. 5B includes a link name 550, a launch path 534, and a copy URI link button 536 for each link 532. Further, this view illustrates a launch path pop-up 552 showing the full launch path 534 for one of the links 532, as well as a copy URI link pop-up 554 showing a copy string that includes the full URI 542 of one of the other links 532.

Examples of architecture 100 are operable with virtualized and non-virtualized storage solutions. FIG. 6 illustrates a virtualization architecture 600 that may be used as a version of computing platform. Virtualization architecture 600 is comprised of a set of compute nodes 621-623, interconnected with each other and a set of storage nodes 641-643 according to an embodiment. In other examples, a different number of compute nodes and storage nodes may be used. Each compute node hosts multiple objects, which may be virtual machines (VMs, such as base objects, linked clones, and independent clones), containers, applications, or any compute entity (e.g., computing instance or virtualized computing instance) that consumes storage, such as local storage 661, 662, 663 (e.g., storage devices directly attached to the compute nodes 621, 622, 623) or storage provided by other devices or services (e.g., SAN storage, network-attached storage (NAS), cloud storage, storage provided by storage nodes 641, 642, 643, or the like). When objects are created, they may be designated as global or local, and the designation is stored in an attribute. For example, compute node 621 hosts objects 601, 602, and 603; compute node 622 hosts objects 604, 605, and 606; and compute node 623 hosts objects 607 and 608. Some of objects 601-608 may be local objects. In some examples, a single compute node may host 50, 100, or a different number of objects. Each object uses a VM disk (VMDK), for example VMDKs 611-618 for each of objects 601-608, respectively. Other implementations using different formats are also possible. A virtualization platform 630, which includes hypervisor functionality at one or more of compute nodes 621, 622, and 623, manages objects 601-608. In some examples, various components of virtualization architecture 600, for example compute nodes 621, 622, and 623, and storage nodes 641, 642, and 643 are implemented using one or more computing apparatus such as computing apparatus 718 of FIG. 7.

Virtualization software that provides software-defined storage (SDS), by pooling storage nodes across a cluster, creates a distributed, shared data store, for example a storage area network (SAN). Thus, objects 601-608 may be virtual SAN (vSAN) objects. In some distributed arrangements, servers are distinguished as compute nodes (e.g., compute nodes 621, 622, and 623) and storage nodes (e.g., storage nodes 641, 642, and 643). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 641-643 each include multiple physical storage components, which may include flash, SSD, NVMe, PMEM, and QLC storage solutions. For example, storage node 641 has storage 651, 652, 652, and 653; storage node 642 has storage 655 and 656; and storage node 643 has storage 657 and 658. In some examples, a single storage node may include a different number of physical storage components.

In the described examples, storage nodes 641-643 are treated as a SAN with a single global object, enabling any of objects 601-608 to write to and read from any of storage 651-658 using a virtual SAN component 632. Virtual SAN component 632 executes in compute nodes 621-623. Using the disclosure, compute nodes 621-623 are able to operate with a wide range of storage options. In some examples, compute nodes 621-623 each include a manifestation of virtualization platform 630 and virtual SAN component 632. Virtualization platform 630 manages the generating, operations, and clean-up of objects 601 and 602. Virtual SAN component 632 permits objects 601 and 602 to write incoming data from object 601 and incoming data from object 602 to storage nodes 641, 642, and/or 643, in part, by virtualizing the physical storage components of the storage nodes.

### Additional Examples

An example method of executing an application based on a uniform resource identifier (URI) comprises: receiving, at a client computing device, user input indicating activation of the URI, the URI comprising a scheme name, an application identifier for an application, and a launch identifier; identifying, by the client computing device, an agent service registered to process the URI based on the scheme name; transmitting an application request to an application manager server, the application request including at least the application identifier and the launch identifier; receiving, from the application manager server, an assignment of a virtual disk associated with the application and an execution path of the application; mounting, at the client computing device, the virtual disk; and executing the application from the virtual disk using the execution path.

An example computer system comprises: at least one processor of an agent device; and a non-transitory computer readable medium having stored thereon program code executable by the at least one processor, the program code causing the at least one processor to: receive user input indicating activation of a uniform resource identifier (URI), the URI comprising a scheme name, an application identifier for an application, and a launch identifier; identify an agent process executing on the agent device that is registered to process the URI based on the scheme name; send an application request to an application manager device, the application request including at least the application identifier and the launch identifier; receive, from the application manager device, provisioning of a virtual disk associated with the application and an execution path of the application; mount the virtual disk on the agent device; and execute the application from the virtual disk using the execution path.

An example non-transitory computer storage medium has stored thereon program code executable by a processor, the program code embodying a program code method comprises: receiving, at a client computing device, user input indicating activation of the URI, the URI comprising a scheme name, an application identifier for an application, and a launch identifier; identifying, by the client computing device, an agent service registered to process the URI based on the scheme name; transmitting an application request to an application manager server, the application request including at least the application identifier and the launch identifier; receiving, from the application manager server, an assignment of a virtual disk associated with the application and an execution path of the application; mounting, at the client computing device, the virtual disk; and executing the application from the virtual disk using the execution path.

An example method comprises: creating a launch identifier for an application by hashing an execution path of the application; creating a uniform resource identifier (URI) for the application, the URI comprising a scheme name, an application identifier assigned to the application, and the launch identifier; transmitting the URI to one or more other computing devices for use in requesting on-demand delivery of the application; receiving, from an agent device, an application request to provision the application to the agent device, the application request including at least the application identifier, the application request being in response to activation of the URI from a user; and provisioning the application to the agent device, thereby causing the agent device to execute the application on behalf of the user on the agent device.

An example computer system comprises: at least one processor of an application manager device; and a non-transitory computer readable medium having stored thereon program code executable by the at least one processor, the program code causing the at least one processor to: create a launch identifier for an application by hashing an execution path of the application; create a uniform resource identifier (URI) for the application, the URI comprising a scheme name, an application identifier assigned to the application, and the launch identifier; transmit the URI to one or more other computing devices for use in requesting on-demand delivery of the application; receive, from an agent device, an application request to provision the application to the agent device, the application request including at least the application identifier, the application request being in response to activation of the URI from a user; and provision the application to the agent device, thereby causing the agent device to execute the application on behalf of the user on the agent device.

An example non-transitory computer storage medium has stored thereon program code executable by a processor, the program code embodying a program code method comprises: creating a launch identifier for an application by hashing an execution path of the application; creating a uniform resource identifier (URI) for the application, the URI comprising a scheme name, an application identifier assigned to the application, and the launch identifier; transmitting the URI to one or more other computing devices for use in requesting on-demand delivery of the application; receiving, from an agent device, an application request to provision the application to the agent device, the application request including at least the application identifier, the application request being in response to activation of the URI from a user; and provisioning the application to the agent device, thereby causing the agent device to execute the application on behalf of the user on the agent device.

Another example computer system comprises: a processor; and a non-transitory computer readable medium having stored thereon program code executable by the processor, the program code causing the processor to perform a method disclosed herein. Another example non-transitory computer storage medium has stored thereon program code executable by a processor, the program code embodying a method disclosed herein.

Alternatively, or in addition to the other examples described herein, examples include any combination of the following:
receiving user input indicating activation of the URI;
a URI comprising a scheme name, an application identifier for an application, and a launch identifier;
identifying an agent service registered to process the URI based on the scheme name;
transmitting an application request to an application manager server;
an application request including at least the application identifier and the launch identifier;
receiving an assignment of a virtual disk associated with the application and an execution path of the application;
mounting a virtual disk;
installing an application in response to a URI activation;
requesting an application installation package in response to a URI activation;
executing the application from the virtual disk using the execution path;
creating a launch identifier for an application by hashing an execution path of the application;
creating a uniform resource identifier (URI) for an application, the URI comprising a scheme name, an application identifier assigned to the application, and the launch identifier;
transmitting a URI to one or more other computing devices for use in requesting on-demand delivery of the application;
receiving an application request to provision an application;
an application request including at least the application identifier, the application request being in response to activation of the URI from a user;
provisioning an application to an agent device, thereby causing the agent device to execute the application on behalf of the user on the agent device;
hashing an execution path;
encrypting an execution path;
installing an application agent on an agent device;
an agent device being a virtual machine;
an agent device being a user computing device;
an agent device providing a virtual desktop or desktop session to a user;
a URI that includes a command;
a launch identifier is a hash of the execution path;
registering a URI handler of the client computing device to redirect URI processing to the agent service for URIs having the scheme name;
executing an application as a user other than a requesting user that activates the URI;
requesting, from the application manager server, the execution path of an application;
caching application identifiers and associated execution paths for other applications previously mounted on the client computing device;
a URI that includes a command, wherein the command includes one of (i) a launch command configured to cause delivery and launch of the application and (ii) a deliver command configured to cause delivery of the application;
displaying of a graphical user interface (GUI);
a GUI being configured to display a URI associated with an application;
a GUI configured to provide a URI copy button, the URI copy button being configured to copy the URI to a buffer of the agent device;
creating a virtual disk used for an application;
installing an application on the virtual disk;
creating an application package for an application, the application package including the virtual disk and the URI;
providing an application programming interface (API) configured to respond to requests from the agent device;
receiving an execution path request from the agent device for the execution path of the application, the execution path request including the application identifier;
transmitting an execution path to the agent device in response to the execution path request;
an input receiver configured to receive user input indicating activation of the URI;
a URI handler configured to identify an agent service registered to process the URI based on the scheme name;
a transmitter configured to transmit an application request to an application manager server;
a mounter configured to receive an assignment of a virtual disk associated with the application and an execution path of the application and mount a virtual disk;
an installer configured to install an application in response to a URI activation;
an executor configured to execute an application;
a hasher configured to hash or encrypt an execution path of an application;
an ID generator configured to generate an application GUID for an application;
an RDSH configured to provide virtual desktops to user devices;
a packager configured to package applications; and
a URI generator configured to generate URIs for applications.

### Exemplary Operating Environment

The present disclosure is operable with a computing device (computing apparatus) according to an embodiment shown as a functional block diagram 700 in FIG. 7. FIG. 7 illustrates a block diagram of an example computing apparatus that may be used as a component of the architectures of FIG. 1 and FIG. 6. In an embodiment, components of a computing apparatus 718 are implemented as part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. Platform software comprising an operating system 720 or any other suitable platform software may be provided on the computing apparatus 718 to enable application software 721 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 718. Computer-readable media may include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, a computer storage medium or media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that the storage may be distributed or located remotely and accessed via a network or other communication link (e.g., using a communication interface 723). Computer storage media are tangible, non-transitory, and are mutually exclusive to communication media.

The computing apparatus 718 may comprise an input/output controller 724 configured to output information to one or more output devices 725, for example a display or a speaker, which may be separate from or integral to the electronic device. The input/output controller 724 may also be configured to receive and process an input from one or more input devices 726, for example, a keyboard, a microphone, or a touchpad. In one embodiment, the output device 725 also acts as the input device. An example of such a device may be a touch sensitive display. The input/output controller 724 may also output data to devices other than the output device, e.g., a locally connected printing device. In some embodiments, a user may provide input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method of executing an application based on a uniform resource identifier (URI), the method comprising:
receiving, at a client computing device, user input indicating activation of the URI, the URI comprising a scheme name, an application identifier for an application, and a launch identifier;
transmitting an application request to an application manager server, the application request including at least the application identifier and the launch identifier;
receiving, from the application manager server, an assignment of a virtual disk associated with the application and an execution path of the application;
mounting, at the client computing device, the virtual disk; and
executing the application from the virtual disk using the execution path.

2. The computerized method of claim 1, wherein the launch identifier is a hash of the execution path.

3. The computerized method of claim 1, further comprising:
registering a URI handler of the client computing device to redirect URI processing to an agent service for URIs having the scheme name; and
identifying, by the client computing device and in response to the receiving of the user input, the agent service registered to process the URI based on the scheme name.

4. The computerized method of claim 1, wherein executing the application includes executing the application as a user other than a requesting user that activates the URI.

5. The computerized method of claim 1, further comprising requesting, from the application manager server, the execution path of the application.

6. The computerized method of claim 1, further comprising caching a plurality of application identifiers and associated execution paths for a plurality of applications previously mounted on the client computing device.

7. The computerized method of claim 1, wherein the URI further includes a command, wherein the command includes one of (i) a launch command configured to cause delivery and launch of the application and (ii) a deliver command configured to cause delivery of the application.

8. A computer system comprising:
at least one processor of an agent device; and
a non-transitory computer readable medium having stored thereon program code executable by the at least one processor, the program code causing the at least one processor to:
receive user input indicating activation of a uniform resource identifier (URI), the URI comprising a scheme name, an application identifier for an application, and a launch identifier;
send an application request to an application manager device, the application request including at least the application identifier and the launch identifier;
receive, from the application manager device, provisioning of a virtual disk associated with the application and an execution path of the application;
mount the virtual disk on the agent device; and
execute the application from the virtual disk using the execution path.

9. The computer system of claim 8, wherein the launch identifier is a hash of the execution path.

10. The computer system of claim 8, wherein the program code further causes the at least one processor to:
register a URI handler of the agent device to redirect URI processing to an agent process for URIs having the scheme name; and
identifying, in response to the receiving of the user input, the agent process registered to process the URI based on the scheme name.

11. The computer system of claim 8, wherein executing the application includes executing the application as a user other than a requesting user that activates the URI via the user input.

12. The computer system of claim 8, wherein the program code further causes the at least one processor to send an execution path request message to the application manager device requesting the execution path of the application.

13. The computer system of claim 8, wherein the program code further causes the at least one processor to store a plurality of application identifiers and associated execution paths for a plurality of applications previously mounted on the agent device.

14. The computer system of claim 8, wherein the URI further includes a command, wherein the command includes one of (i) a launch command configured to cause delivery and launch of the application and (ii) a deliver command configured to cause delivery of the application.

15. A non-transitory computer storage medium having stored thereon program code executable by a processor, the program code embodying a program code method comprising:
creating a launch identifier for an application by hashing an execution path of the application;
creating a uniform resource identifier (URI) for the application, the URI comprising a scheme name, an application identifier assigned to the application, and the launch identifier;
transmitting the URI to one or more other computing devices for use in requesting on-demand delivery of the application;
receiving, from an agent device, an application request to provision the application to the agent device, the application request including at least the application identifier, the application request being in response to activation of the URI from a user; and
provisioning the application to the agent device, thereby causing the agent device to execute the application on behalf of the user on the agent device.

16. The non-transitory computer storage medium of claim 15, wherein the URI further comprises a command, wherein the command includes one of (i) a launch command configured to cause delivery and launch of the application and (ii) a deliver command configured to cause delivery of the application.

17. The non-transitory computer storage medium of claim 15, the method further comprising causing display of a graphical user interface (GUI), the GUI being configured to display the URI associated with the application.

18. The non-transitory computer storage medium of claim 17, wherein the GUI is further configured to provide a URI copy button, the URI copy button being configured to copy the URI to a buffer of the agent device.

19. The non-transitory computer storage medium of claim 15, the method further comprising:
creating a virtual disk for the application;
installing the application on the virtual disk; and
creating an application package for the application, the application package including the virtual disk and the URI.

20. The non-transitory computer storage medium of claim 15, the method further comprising:
providing an application programming interface (API) configured to respond to requests from the agent device;
receiving, via the API, an execution path request from the agent device for the execution path of the application, the execution path request including the application identifier; and
transmitting the execution path to the agent device in response to the execution path request.
